(19) United States
(12) Patent Application Publication
(10) Pub. No.: US 2015/0000776 A1
(43) Pub. Date: Jan. 1, 2015

(54) FLOW ADJUSTING APPARATUS

(71) Applicant: DISCO CORPORATION, Tokyo (JP)

(72) Inventor: Takeshi Sunagawa, Tokyo (JP)

(21) Appl. No.: 14/307,110

(22) Filed: Jun. 17, 2014

(30) Foreign Application Priority Data
Jun. 28, 2013 (JP) 2013-136273

(51) Int. Cl. F16K 7/04

(52) U.S. Cl. CPC F16K 7/04
USPC 137/883

(57) ABSTRACT

A flow adjusting apparatus adjusts the flow rate of a fluid flowing in a plurality of tubes. The flow adjusting apparatus includes a tube coupling joint having a joint body and a plurality of engaging lugs. The joint body has a plurality of connection holes for connecting the tubes, respectively. The engaging lugs are mounted on the inner circumferential surfaces of the connection holes of the joint body and engage the outer circumferential surfaces of the tubes, respectively. The flow adjusting apparatus further includes a plurality of inner sleeves having outer diameters respectively corresponding to the inner diameters of the tubes. The inner sleeves increase the engaging forces of the engaging lugs against the outer circumferential surfaces of the tubes inserted in the connection holes of the joint body. The inner sleeves have different inner diameters to produce different flow rates of the fluid flowing in the tubes.

### BACKGROUND OF THE INVENTION

1. Field of the Invention

The present invention relates to a flow adjusting apparatus for adjusting the flow rate of a fluid flowing in a plurality of tubes.

2. Description of the Related Art

In a semiconductor device fabrication process, a plurality of crossing division lines called streets are formed on the front side of a substantially disk-shaped semiconductor wafer to thereby partition a plurality of regions where a plurality of devices such as ICs and LSIs are respectively formed. The back side of the semiconductor wafer is ground by a grinding apparatus to reduce the thickness of the semiconductor wafer to a predetermined thickness. Thereafter, the semiconductor wafer is divided along the streets by a cutting apparatus or a laser processing apparatus to thereby obtain the individual devices divided from each other.

The grinding apparatus for grinding the back side of a wafer such as a semiconductor wafer includes a chuck table for holding the wafer under suction, grinding means having a grinding wheel for grinding the wafer held on the chuck table, the grinding wheel being mounted on a rotating spindle, and cleaning means for cleaning the wafer ground by the grinding means (see Japanese Patent Laid-open No. 2005-153090, for example).

The cutting apparatus for dividing a wafer into the individual devices includes a chuck table for holding the wafer under suction, cutting means having a cutting blade for cutting the wafer held on the chuck table, the cutting blade being mounted on a rotating spindle, and cleaning means for cleaning the wafer cut by the cutting means (see Japanese Patent Laid-open No. 2001-7058, for example).

In a processing apparatus including the grinding apparatus and the cutting apparatus as mentioned above, many means including a chuck table are connected through tubes to a vacuum source, and many means including a spindle unit are connected through tubes to a high-pressure air source. Then, air is sucked from the means through the tubes to the vacuum source, or air is supplied from the high-pressure air source through the tubes to the means. In each case, it is necessary to adjust the flow rate of the air to a required value according to function. Accordingly, these means are connected through suitable restriction valves to the vacuum source or the high-pressure air source.

### SUMMARY OF THE INVENTION

The restriction valves are provided in fluid passages connected to the vacuum source or the high-pressure air source. However, the restriction valves are relatively expensive, and it is necessary to configure a processing apparatus including various restriction valves, causing an increase in cost.

It is therefore an object of the present invention to provide a flow adjusting apparatus which is inexpensive and can easily adjust the flow rate of a fluid flowing in tubes.

In accordance with an aspect of the present invention, there is provided a flow adjusting apparatus for adjusting the flow rate of a fluid flowing in a plurality of tubes, including a tube coupling joint including a joint body having a plurality of connection holes for receiving the plurality of tubes, respectively, and a plurality of engaging means mounted on the inner circumferential surfaces of the plurality of connection holes of the joint body, respectively, the plurality of engaging means having a plurality of engaging lugs for engaging the outer circumferential surfaces of the plurality of tubes, respectively; and a plurality of inner sleeves having outer diameters respectively corresponding to the inner diameters of the tubes and adapted to be fitted in the front end portions of the tubes, respectively, the inner sleeves functioning to increase the engaging forces of the engaging lugs of the plurality of engaging means to be applied to the outer circumferential surfaces of the tubes inserted in the connection holes of the joint body; the inner sleeves having different inner diameters according to different flow rates of the fluid flowing in the tubes.

Preferably, the plurality of inner sleeves are color-coded according to their different inner diameters.

As described above, the flow adjusting apparatus according to the present invention includes the inner sleeves having outer diameters respectively corresponding to the inner diameters of the tubes and adapted to be fitted in the front end portions of the tubes, the inner sleeves functioning to increase the engaging forces of the engaging lugs of the engaging means to be applied to the outer circumferential surfaces of the tubes inserted in the connection holes of the joint body, wherein the inner sleeves have different inner diameters according to different flow rates of the fluid flowing in the tubes. Accordingly, it is unnecessary to configure a processing apparatus including various restriction valves, thereby reducing a cost for the processing apparatus.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is an exploded perspective view of a flow adjusting apparatus according to a preferred embodiment of the present invention;

FIG. 2 is a sectional view of a tube coupling joint constituting the flow adjusting apparatus shown in FIG. 1; and

FIG. 3 is a sectional view of the flow adjusting apparatus shown in FIG. 1.

### DETAILED DESCRIPTION OF THE PREFERRED EMBODIMENT

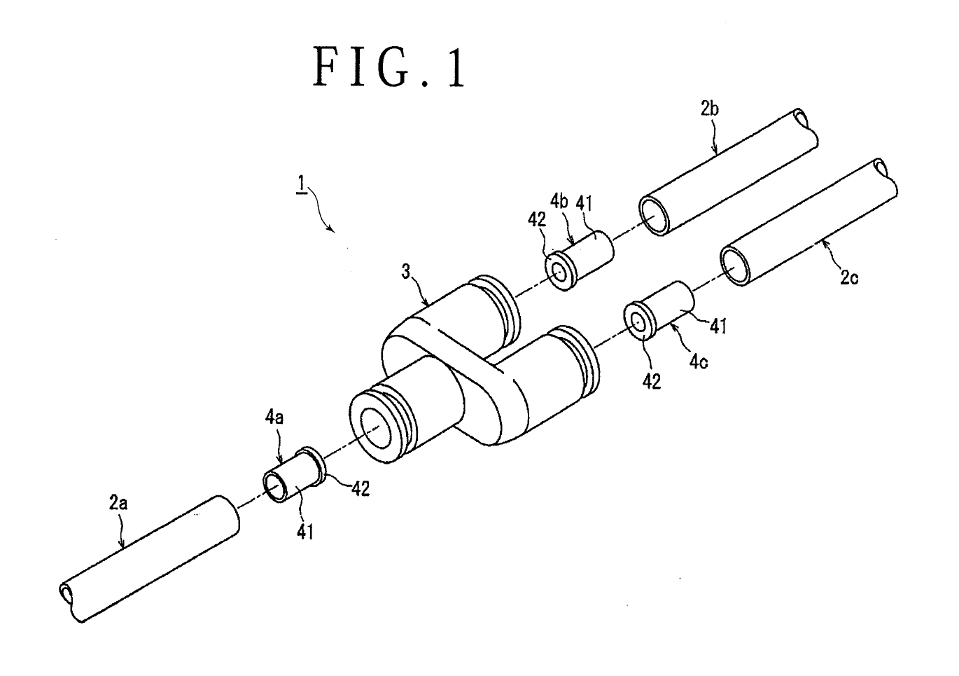

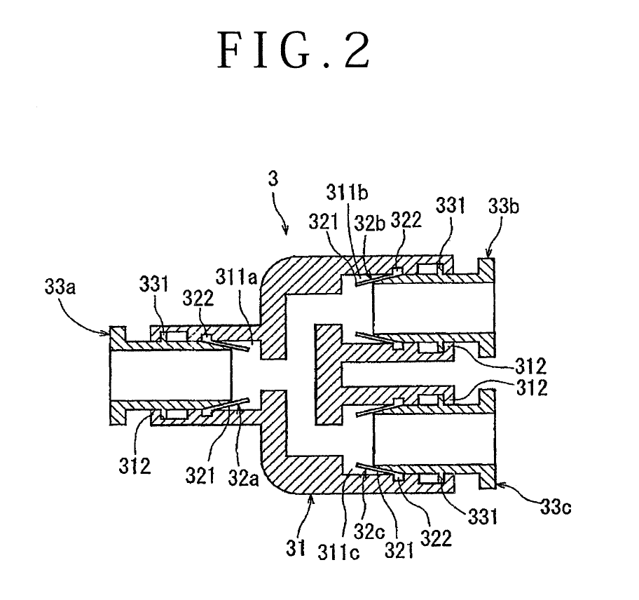

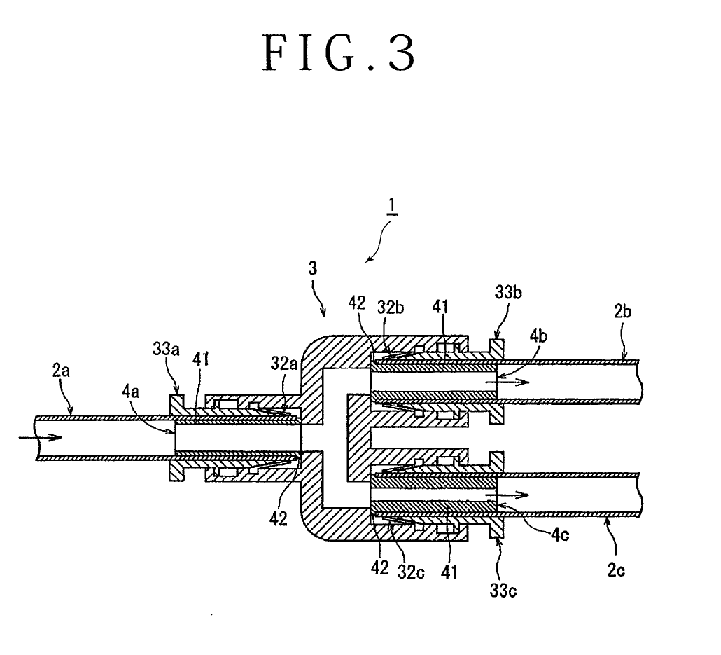

A preferred embodiment of the flow adjusting apparatus according to the present invention will now be described in detail with reference to the attached drawings. FIG. 1 is an exploded perspective view of a flow adjusting apparatus 1 according to a preferred embodiment of the present invention. FIG. 2 is a sectional view of a tube coupling joint 3 constituting the flow adjusting apparatus 1 shown in FIG. 1. FIG. 3 is a sectional view of the flow adjusting apparatus 1 shown in FIG. 1.

The flow adjusting apparatus 1 includes the tube coupling joint 3 for coupling a plurality of tubes 2a, 2b, and 2c. The tube coupling joint 3 includes a joint body 31 formed of a suitable synthetic resin. The joint body 31 has three connection holes 311a, 311b, and 311c. The three connection holes 311a, 311b, and 311c have the same inner diameter and communicate with each other. Three engaging means 32a, 32b, and 32c are provided on the inner circumferential surfaces of the three connection holes 311a, 311b, and 311c of the joint body 31, respectively. The three engaging means 32a, 32b, and 32c function to engage the outer circumferential surfaces of the three tubes 2a, 2b, and 2c inserted in the three connection holes 311a, 311b, and 311c, respectively. Each of the three engaging means 32a, 32b, and 32c is composed of a plurality of engaging lugs 321 for engaging the outer circumferential surface of each of the tubes 2a, 2b, and 2c and a lug holding portion 322 for holding the engaging lugs 321 on the inner circumferential surface of each of the connection holes 311a, 311b, and 311c.

Three cylindrical release bushes 33a, 33b, and 33c are axially slidably fitted in the end portions of the three connection holes 311a, 311b, and 311c of the joint body 31 constituting the tube coupling joint 3, respectively. These release bushes 33a, 33b, and 33c function to release the engagement of the engaging lugs 321 with the outer circumferential surfaces of the tubes 2a, 2b, and 2c. Each of the release bushes 33a, 33b, and 33c has a radial projection 331 projecting radially from the outer circumference. The radial projection 331 is adapted to come into abutment against a stop portion 312 formed at the end portion of each of the three connection holes 311a, 311b, and 311c of the joint body 31, thereby preventing the disconnection of the release bushes 33a, 33b, and 33c. The configuration of the joint body 31, the engaging means 32a, 32b, and 32c each having the engaging lugs 321 and the lug holding portion 322, and the release bushes 33a, 33b, and 33c may be any conventional configuration and a further detailed description are therefore omitted herein.

As shown in FIGS. 1 and 3, the flow adjusting apparatus 1 further includes a plurality of inner sleeves 4a, 4b, and 4c having outer diameters respectively corresponding to the inner diameters of the tubes 2a, 2b, and 2c and adapted to be fitted in the front end portions of the tubes 2a, 2b, and 2c, respectively. The inner sleeves 4a, 4b, and 4c function to increase the engaging forces of the engaging lugs 321 of the engaging means 32a, 32b, and 32c to be applied to the outer circumferential surfaces of the tubes 2a, 2b, and 2c inserted in the connection holes 311a, 311b, and 311c of the joint body 31. Each of the inner sleeves 4a, 4b, and 4c is composed of a tube supporting portion 41 adapted to be fitted in the front end portion of each of the tubes 2a, 2b, and 2c and a flange portion 42 formed at one end of the tube supporting portion 41 so as to radially project. These inner sleeves 4a, 4b, and 4c have different inner diameters according to different flow rates of a fluid flowing in the tubes 2a, 2b, and 2c. For example, the inner sleeve 4a has an inner diameter of 8 mm, the inner sleeve 4b has an inner diameter of 6 mm, and the inner sleeve 4c has an inner diameter of 4 mm. The inner sleeves 4a, 4b, and 4c may be formed of metal such as aluminum alloy and stainless steel or a suitable synthetic resin. Further, the inner sleeves 4a, 4b, and 4c are preferably color-coded according to their different inner diameters.

In coupling the tubes 2a, 2b, and 2c to the tube coupling joint 3, the tube supporting portions 41 of the inner sleeves 4a, 4b, and 4c are first fitted into the front end portions of the tubes 2a, 2b, and 2c, respectively. At this time, the inner sleeves 4a, 4b, and 4c can be reliably fitted into the tubes 2a, 2b, and 2c, respectively, without error in the case that the inner sleeves 4a, 4b, and 4c are color-coded according to their different inner diameters. Thereafter, the front end portions of the tubes 2a, 2b, and 2c with the tube supporting portions 41 of the inner sleeves 4a, 4b, and 4c fitted therein are inserted through the release bushes 33a, 33b, and 33c, fitted in the connection holes 311a, 311b, and 311c of the joint body 31, respectively, so that the engaging lugs 321 of the engaging means 32a, 32b, and 32c come into engagement with the outer circumferential surfaces of the tubes 2a, 2b, and 2c, respectively, thereby preventing the disconnection of the tubes 2a, 2b, and 2c.

In the operation of the flow adjusting apparatus 1, a fluid supplied from a fluid source (not shown) to the tube 2a is introduced through the inner sleeve 4a into the joint body 31 and then distributed through the inner sleeves 4b and 4c and the tubes 2b and 2c to predetermined apparatuses. In this preferred embodiment, the inner diameter of the inner sleeve 4a is set to 8 mm, the inner diameter of the inner sleeve 4b is set to 6 mm, and the inner diameter of the inner sleeve 4c is set to 4 mm. Accordingly, in the case that air is supplied to the tube 2a at a flow rate of 32.5 liters/minute and introduced through the inner sleeve 4a into the joint body 31, a part of the air flows through the inner sleeve 4b to the tube 2b at a flow rate of 22.5 liters/minute and the other air flows through the inner sleeve 4c to the tube 2c at a flow rate of 10.0 liters/minute.

In the case of disconnecting the tubes 2a, 2b, and 2c from the joint body 31, the release bushes 33a, 33b, and 33c are pushed inward of the joint body 31, so that the release bushes 33a, 33b, and 33c slide to deform the engaging lugs 321 in the radially outward direction, thereby releasing the engagement of the engaging lugs 321 with the outer circumferential surfaces of the tubes 2a, 2b, and 2c. Thus, the tubes 2a, 2b, and 2c can be easily disconnected from the joint body 31.

As described above, the flow adjusting apparatus 1 includes the inner sleeves 4a, 4b, and 4c having outer diameters respectively corresponding to the inner diameters of the tubes 2a, 2b, and 2c and adapted to be fitted in the front end portions of the tubes 2a, 2b, and 2c, the inner sleeves 4a, 4b, and 4c functioning to increase the engaging forces of the engaging lugs 321 of the engaging means 32a, 32b, and 32c to be applied to the outer circumferential surfaces of the tubes 2a, 2b, and 2c inserted in the connection holes 311a, 311b, and 311c of the joint body 31, wherein the inner sleeves 4a, 4b, and 4c have different inner diameters according to different flow rates of the fluid flowing in the tubes 2a, 2b, and 2c. Accordingly, it is unnecessary to configure a processing apparatus including various restriction valves, thereby reducing a cost for the processing apparatus.

Having thus described a specific preferred embodiment of the present invention, it should be noted that the present invention is not limited to the above preferred embodiment, but various modifications may be made within the scope of the present invention. For example, while the flow adjusting apparatus in the above preferred embodiment is designed to adjust the flow rate of air, the present invention is applicable also to a flow adjusting apparatus for adjusting the flow rate of any other fluids such as water and oil.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A flow adjusting apparatus for adjusting the flow rate of a fluid flowing in a plurality of tubes, comprising:
a tube coupling joint including a joint body having a plurality of connection holes for receiving said plurality of tubes, respectively, and a plurality of engaging means mounted on the inner circumferential surfaces of said plurality of connection holes of said joint body, respectively, said plurality of engaging means having a plurality of engaging lugs for engaging the outer circumferential surfaces of said plurality of tubes, respectively; and
a plurality of inner sleeves having outer diameters respectively corresponding to the inner diameters of said tubes and adapted to be fitted in the front end portions of said tubes, respectively, said inner sleeves functioning to increase the engaging forces of said engaging lugs of said plurality of engaging means to be applied to the outer circumferential surfaces of said tubes inserted in said connection holes of said joint body;
said inner sleeves having different inner diameters according to different flow rates of said fluid flowing in said tubes.

2. The flow adjusting apparatus according to claim 1, wherein said plurality of inner sleeves are color-coded according to their different inner diameters.
